(19) United States
(12) Patent Application Publication
(10) Pub. No.: US 2013/0272388 A1
(43) Pub. Date: Oct. 17, 2013

(54) APPARATUS, METHOD, AND PROGRAM FOR CODING IMAGE AND APPARATUS, METHOD, AND PROGRAM FOR DECODING IMAGE

(71) Applicant: CANON KABUSHIKI KAISHA, Tokyo (JP)

(72) Inventor: Masato Shima, Tokyo (JP)

(73) Assignee: CANON KABUSHIKI KAISHA, Tokyo (JP)

(21) Appl. No.: 13/861,197

(22) Filed: Apr. 11, 2013

(30) Foreign Application Priority Data
Apr. 13, 2012 (JP) 2012-092215

(51) Int. Cl. H04N 7/26

(52) U.S. Cl. CPC H04N 19/0009
USPC 375/240.03

(57) ABSTRACT

Provided is a method for coding an image to generate an image bit stream, the method including a first coding step of coding an image in units of blocks in a first coding mode in which quantization is performed; a second coding step of coding an image in units of blocks in a second coding mode in which quantization is not performed; a determination step of determining which of the first coding mode or the second coding mode is used to code the image in units of blocks; and an integrally coding step of, in the case where it is determined in the determination step that coding is performed using the second coding step, switching between the first coding step and the second coding step in units of blocks and coding information indicating that switching is performed in units of blocks as block-by-block mode-switching information.

### BACKGROUND OF THE INVENTION

1. Field of the Invention

The present invention relates to an apparatus, method, and program for coding an image and an apparatus, method, and program for decoding an image, and in particular, to a mixed process of lossless coding and lossy coding.

2. Description of the Related Art

A known example of video compression formats is H.264/MPEG-4 AVC (hereinafter abbreviated as H.264) (ITU-T H.264 (03/2010) Advanced video coding for generic audiovisual services).

H.264 allows lossless coding by executing a transformation bypass process for bypassing orthogonal transformation and quantization process.

An action to develop an international standard of a higher-efficiency coding scheme as a successor to H.264 has recently been started. Joint collaborative team on video coding (JCT-VC) was established between the ISO/IEC and the ITU-T. The JCT-VC pursues standardization thereof as a high-efficiency video coding (HEVC) scheme (hereinafter referred to as HEVC). For the HEVC, separation in larger block size than a conventional macro block (16*16 pixels) is under consideration as a target screen size increases. This large-sized basic block is called a largest coding unit (LCU), and a maximum size of 64*64 pixels is under consideration (JCT-VC, Doc. JCTVC-H1003, the Internet <http://phenix.int-evry.fr/jct/doc_end_user/documents/8_San%20Jose/wg11/>).

The LCU can be further divided into subblocks serving as units for prediction and transformation, so that quantization parameters can also be controlled in a unit smaller than the LCU. As with H.264, lossless coding in which orthogonal transformation and quantization processes are bypassed is also under consideration, in which lossless coding and ordinary lossy coding can be mixed in a single picture.

In HEVC, as in H.264, switching to a lossless coding block is performed depending on a combination of the flag of a sequence header and a quantization parameter. Specifically, in H.264, in the case where a qpprime_y_zero_transform_bypass_flag code is 1, and the quantization parameter of a coding target block is equivalent to 0, the block is subjected to lossless coding. On the other hand, in HEVC, in the case where a qpprime_y_zero_transquant_bypass_flag code is 1, and the quantization parameter of the coding target block is equivalent to 0, the block is subjected to lossless coding.

In H.264, since quantization parameters can be controlled only in units of macro blocks, which is a unit for processing, lossless coding and lossy coding are not mixed in the same macro block. However, in HEVC, since quantization parameters can be controlled in a unit smaller than that of the LCU, lossless coding and lossy coding can be mixed in the same LCU. This causes, when implementing HEVC, in particular, when achieving pipeline processing in units of LCUs, execution and nonexecution of transformation and quantization processes are mixed in the same pipeline, thus causing a difficulty in implementation.

### SUMMARY OF THE INVENTION

The present invention is made to solve the above problems. Accordingly, the present invention enhances the ease of implementation of HEVC by eliminating a mixture of lossless coding and lossy coding in the same LCU.

To solve the above problems, an image coding method according to an aspect of the present invention has the following configuration. The method for coding an image to generate an image bit stream includes a first coding step of coding an image in units of blocks in a first coding mode in which quantization is performed; a second coding step of coding an image in units of blocks in a second coding mode in which quantization is not performed; a determination step of determining which of the first coding mode or the second coding mode is used to code the image in units of blocks; and an integrally coding step of, in the case where it is determined in the determination step that coding is performed using the second coding step, switching between the first coding step and the second coding step in units of blocks and coding information indicating that switching is performed in units of blocks as block-by-block mode-switching information.

According to the above aspect, the process of quantization and transformation or the process of inverse quantization and transformation can be separated in units of blocks, thus facilitating pipeline implementation when lossless coding is used.

Further features of the present invention will become apparent from the following description of exemplary embodiments with reference to the attached drawings.

### BRIEF DESCRIPTION OF THE DRAWINGS

FIG. 1 is a block diagram showing the configuration of an image coding apparatus of a first embodiment.

FIG. 2 is a block diagram showing the configuration of an image coding apparatus of a second embodiment.

FIG. 3 is a block diagram showing the configuration of an image coding apparatus of a third embodiment.

FIG. 4 is a block diagram showing the configuration of an image coding apparatus of a fourth embodiment and a fifth embodiment.

FIG. 5A is a diagram showing an example of a combination of subblock division and quantization control size.

FIG. 5B is a diagram showing an example of a combination of subblock division and quantization control size.

FIG. 5C is a diagram showing an example of a combination of subblock division and quantization control size.

FIG. 5D is a diagram showing an example of a combination of subblock division and quantization control size.

FIG. 5E is a diagram showing an example of a combination of subblock division and quantization control size.

FIG. 5F is a diagram showing an example of a combination of subblock division and quantization control size.

FIG. 5G is a diagram showing an example of a combination of subblock division and quantization control size.

FIG. 6A is a diagram showing an example of the configuration of a bit stream generated in the first to third embodiments and decoded in the fourth and fifth embodiments.

FIG. 6B is a diagram showing an example of the configuration of a bit stream generated in the first to third embodiments and decoded in the fourth and fifth embodiments.

FIG. 6C is a diagram showing an example of the configuration of a bit stream generated in the first to third embodiments and decoded in the fourth and fifth embodiments.

FIG. 7 is a flowchart showing an image coding process in the image coding apparatus according to the first embodiment.

FIG. 8 is a flowchart showing an image coding process in the image coding apparatus according to the second embodiment.

FIG. 9 is a flowchart showing an image coding process in the image coding apparatus according to the third embodiment.

FIG. 10 is a flowchart showing the image decoding process of the image decoding apparatuses according to the fourth and fifth embodiments.

FIG. 11 is a block diagram showing an example of the configuration of computer hardware that can be applied to the image coding apparatuses and image decoding apparatuses according to the above embodiments.

### DESCRIPTION OF THE EMBODIMENTS

The present invention will be described in detail hereinbelow on the basis of embodiments with reference to the accompanying drawings. The configurations shown in the following embodiments are merely examples, and the present invention is not limited to the illustrated configurations.

### First Embodiment

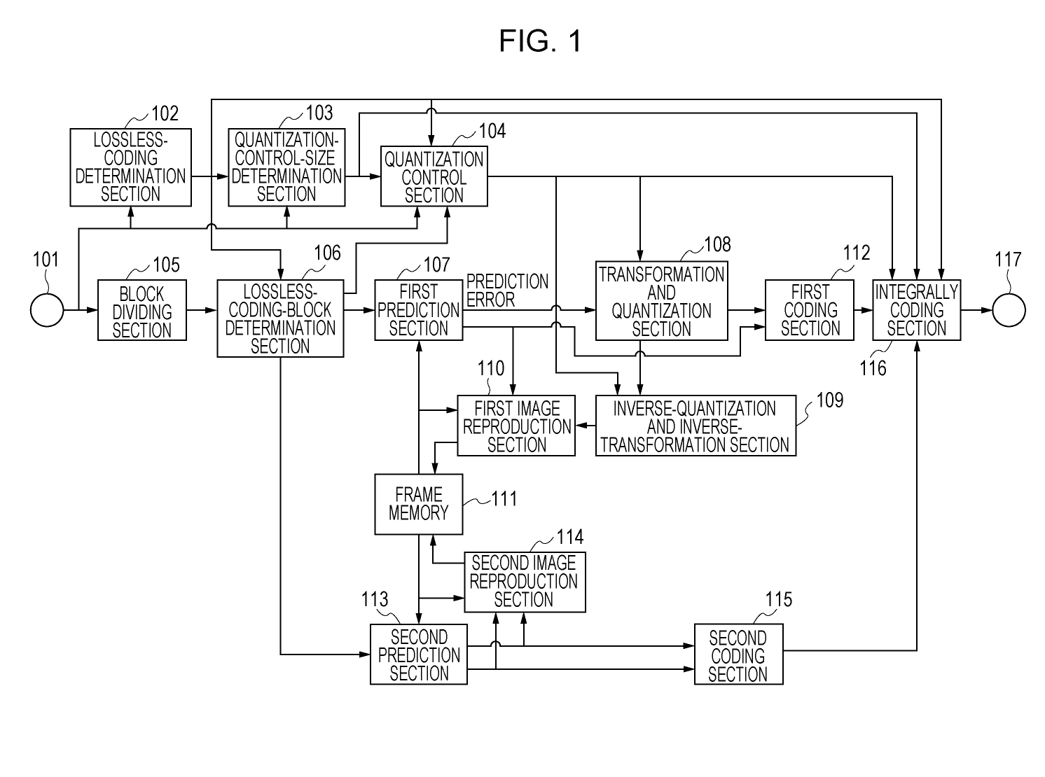

FIG. 1 is a block diagram showing an image coding apparatus of a first embodiment. In FIG. 1, reference numeral 101 denotes a terminal to which image data is to be input; 102 denotes a lossless-coding determination section, which determines whether there is a possibility that a lossless coding block in which lossless coding is to be performed is included in a frame; 103 denotes a quantization-control-size determination section, which determines a size which is a unit for controlling a quantization parameter as a quantization control size; 104 denotes a quantization control section, which determines quantization parameters in the frame in units of the quantization control size.

Reference numeral 105 denotes a block dividing section, which divides an input image into square blocks; 106 denotes a lossless-coding-block determination section, which determines whether a target block is to be subjected to lossless coding or lossy coding in units of the divided blocks; 107 denotes a first prediction section, which divides the individual blocks into subblocks of a size equal to or smaller than the blocks as necessary when lossy coding is selected by the lossless-coding-block determination section 106. Thereafter, the first prediction section 107 performs, in units of subblocks, intra-prediction, which is in-frame prediction, or inter-prediction, which is inter-frame prediction. The first prediction section 107 outputs the sizes of the subblocks, the direction of prediction, and so on as first prediction information and outputs the error between a predicted image and the input image as a first prediction error.

Reference numeral 108 denotes a transformation and quantization section that orthogonally transforms the first prediction error in units of blocks to obtain transformation coefficients and quantizes them to obtain quantization coefficients. Reference numeral 109 denotes an inverse-quantization and inverse-transformation section that inversely quantizes the quantization coefficients to reproduce transformation coefficients and further inversely orthogonally transforms the transformation coefficients to reproduce the first prediction error. Reference numeral 111 denotes a frame memory that stores reproduced image data.

Reference numeral 110 denotes a first image reproduction section. The first image reproduction section 110 generates predicted image data on the basis of the first prediction information output from the first prediction section 107 with reference to the frame memory 111 as appropriate, generates reproduced image data from the predicted image data and the input first prediction error, and outputs the reproduced image data. Reference numeral 112 denotes a first coding section that codes the quantization coefficients and the first prediction information to generate first coded data. Reference numeral 113 denotes a second prediction section. When lossless coding is selected, the second prediction section 113 divides the individual blocks into subblocks of a size equal to or smaller than the blocks as necessary and performs intra-prediction, which is in-frame prediction, or inter-prediction, which is inter-frame prediction. The second prediction section 113 outputs the sizes of the subblocks, the direction of prediction, and so on as second prediction information and outputs the error between a predicted image and the input image as a second prediction error.

Reference numeral 114 denotes a second image reproduction section. The second image reproduction section 114 generates predicted image data on the basis of the second prediction information output from the second prediction section 113 with reference to the frame memory 111 as appropriate, generates reproduced image data from the predicted image data and the input second prediction error, and outputs the reproduced image data. Reference numeral 115 denotes a second coding section that codes the second prediction error and the second prediction information to generate second coded data. Reference numeral 116 denotes an integrally coding section that codes information necessary for decoding a bit stream, generated at the previous stage, into the header, forms a bit stream from the first coded data and the second coded data, and outputs the bit stream. Reference numeral 117 denotes a terminal, from which the bit stream generated by the integrally coding section 116 is output to the outside.

An image coding operation of the above image coding apparatus will be described hereinbelow. Although the first embodiment is configured to input movie data frame by frame, it is possible to input still-image data of one frame.

Image data of one frame input from the terminal 101 is input to the block dividing section 105. Although the first embodiment is configured such that the image data is input also to the lossless-coding determination section 102, the quantization-control-size determination section 103, and the quantization control section 104, it is not essential.

Although the lossless-coding determination section 102 determines whether there is a possibility that an input frame includes a lossless coding block, a method for determination is not particularly limited. It may be determined as appropriate depending on the input image or may be determined depending on an input from a user or from the outside. The determined information is input, as lossless coding information, to the quantization-control-size determination section 103, the quantization control section 104, the lossless-coding-block determination section 106, and the integrally coding section 116.

The quantization-control-size determination section 103 determines a quantization control size, which is the smallest unit for quantization control. A method for determining the quantization control size is not limited; it may be determined as appropriate depending on an input image or may be determined depending on an input from the user or the outside. However, in the case where the lossless coding information input from the lossless-coding determination section 102 indicates that there is a possibility that the input frame includes a lossless coding block, the quantization-control-size determination section 103 sets the quantization control size equal to the block size. The determined quantization control size is output to the quantization control section 104 and the integrally coding section 116.

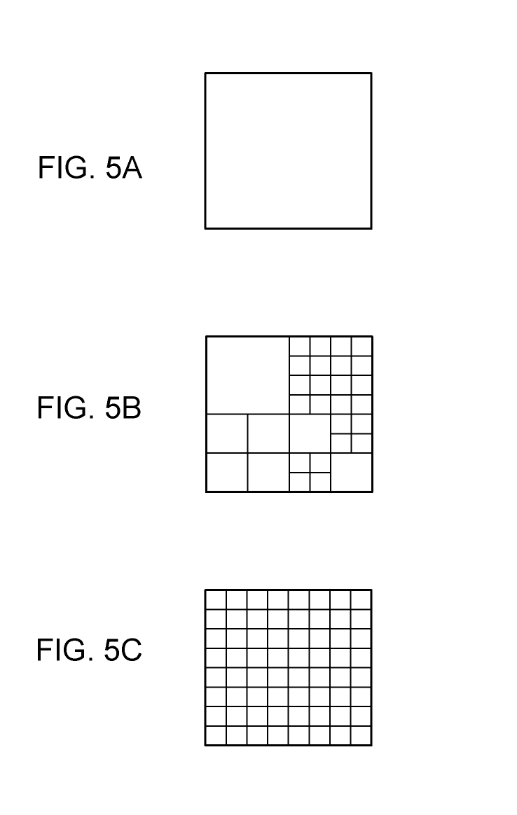

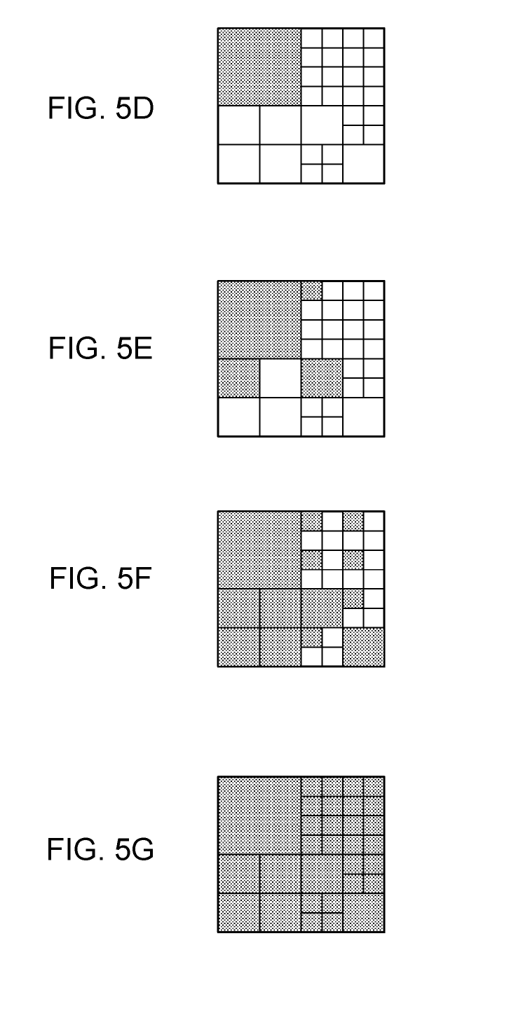

Referring to FIGS. 5A to 5G, examples in which one block in the first embodiment is divided into subblocks of a size equal to or smaller than the block and examples of a combination of a subblocks and a quantization control size. In the first embodiment, the block has a size of 64*64 pixels. The block is recursively divided into small units with a quadtree structure. The divided subblocks have 8*8 pixels at the minimum and 64*64 pixels at the maximum. The thick-frame squares in FIGS. 5A to 5G show blocks of 64*64 pixels, and the thin-frame squares in the thick frame show subblocks of 8*8 to 32*32 pixels. FIG. 5A shows an example in which the block of 64*64 pixels has a subblock of 64*64 pixels without being divided. FIG. 5B shows an example in which the block is divided into small units with a quadtree structure, in which subblocks of a plurality of sizes are mixed; that is, a subblock of 32*32 pixels, which is generated by dividing the block once, is present at the upper left, 16 subblocks of 8*8 pixels, which are obtained by dividing a subblock of 32*32 pixels generated by dividing the block once, further dividing the subblock into four subblocks of 16*16 pixels, and further dividing the subblocks, are present at the upper right, four subblocks of 16*16 pixels, which are obtained by dividing a subblock of 32*32 pixels generated by dividing the block once, are present at the lower left, and subblocks of 16*16 pixels and subblocks of 8*8 pixels, which are obtained by dividing the block once to generate subblocks of 32*32 pixels, further dividing the subblocks to generate four subblocks of 16*16 pixels, and further dividing only the upper right subblocks and the lower left subblocks, are mixed. FIG. 5C shows an example in which the block of 64*64 pixels is divided into subblocks of 8*8 pixels.

On the other hand, in the first embodiment, the quantization control size, which is the smallest unit for quantization control, corresponds to the sizes of the subblocks. Specifically, quantization parameters are controlled in units of 64*64 pixels, in units of 32*32 pixels, in units of 16*16 pixels, or in units of 8*8 pixels. FIG. 5D shows an example in which quantization control is performed on the block divided as shown in FIG. 5B in units of 64*64 pixels, showing that quantization control can be performed only on the upper left filled-in subblock of 32*32 pixels. For the other subblocks, the same quantization parameter is used. FIG. 5E shows an example in which quantization control is performed on the block divided as shown in FIG. 5B in units of 32*32 pixels, showing that quantization control can be performed only on the filled-in subblocks. FIG. 5F shows an example in which quantization control is performed on the block divided as shown in FIG. 5B in units of 16*16 pixels, showing that quantization control can be performed only on the filled-in subblocks. FIG. 5G shows an example in which quantization control is performed on the block divided as shown in FIG. 5B in units of 8*8 pixels, showing that quantization control can be performed on all the filled-in subblocks.

Referring back to FIG. 1, the block dividing section 105 divides the image input from the terminal 101 into square blocks and outputs the input image divided into blocks to the lossless-coding-block determination section 106 at the subsequent stage.

The lossless-coding-block determination section 106 determines whether the target block is to be subjected to lossless coding or lossy coding in units of blocks and outputs the information, as lossless coding block information, to the quantization control section 104. If the lossless coding information input from the lossless-coding determination section 102 indicates a possibility that the target block includes a lossless coding block, the lossless-coding-block determination section 106 determines whether the coding target block is to be subjected to lossless coding or lossy coding. However, if the input lossless coding information does not indicate a possibility that a lossless coding block is included, the lossless-coding-block determination section 106 uniquely determines that the coding target block is to be subjected to lossy coding. Furthermore, if the lossless-coding-block determination section 106 selects lossy coding for the target block, the lossless-coding-block determination section 106 outputs the input block-by-block image to the first prediction section 107. On the other hand, if the lossless-coding-block determination section 106 selects lossless coding for the target block, the lossless-coding-block determination section 106 outputs the input block-by-block image to the second prediction section 113. A method for determination is not particularly limited; it may be determined as appropriate depending on the input image or may be determined depending on an input from a user or from the outside.

The quantization control section 104 receives a quantization control size from the quantization-control-size determination section 103 and determines quantization parameters of the individual subblocks in the frame in units of quantization control size. A method for determining the quantization parameters is not limited; it may be determined as appropriate depending on the input image or may be determined depending on an input from the user or from the outside. However, in the case where a block that the target subblock belongs to is a lossless coding block, that is, in the case where the lossless coding block information input from the lossless-coding-block determination section 106 indicates a lossless coding block, the quantization parameter is set to 0. The quantization parameter to be set is not limited thereto; a combination of a set specified value of quantization parameter and lossless coding information may indicate that the target block is a lossless coding block. In the case where the target block is a lossy coding block but lossless coding information input from the lossless-coding determination section 102 indicates a possibility that a lossless coding block is included, a value other than 0 or a specific value is set. The set quantization parameter is input to the transformation and quantization section 108, the inverse-quantization and inverse-transformation section 109, and the integrally coding section 116.

First, a coding operation for image data of a block in the case where lossy coding is selected by the lossless-coding-block determination section 106 will be described.

The first prediction section 107 performs prediction in units of blocks, generates first prediction information, and divides the individual blocks into subblocks of a size equal to or smaller than the blocks as necessary. A first prediction error is generated as the difference between the input block-by-block image and the predicted image and is input to the transformation and quantization section 108. The first prediction information is input also to the first coding section 112 and the first image reproduction section 110.

The transformation and quantization section 108 orthogonally transforms the input first prediction error to generate a transformation coefficient and quantizes the transformation coefficient on the basis of the quantization parameter input from the quantization control section 104 to generate a quantization coefficient. The generated quantization coefficient is input to the first coding section 112 and the inverse-quantization and inverse-transformation section 109.

The inverse-quantization and inverse-transformation section 109 inversely quantizes the quantization coefficient input from the quantization control section 104 on the basis of the quantization parameter to reproduce the transformation coefficient, inversely orthogonally transforms the reproduced transformation coefficient to reproduce the first prediction error, and outputs the reproduced first prediction error to the first image reproduction section 110.

The first image reproduction section 110 generates a predicted image on the basis of the first prediction information input from the first prediction section 107 with reference to the frame memory 111 as appropriate. The first image reproduction section 110 reproduces image data from the generated predicted image and the first prediction error input from the inverse-quantization and inverse-transformation section 109 and inputs the reproduced image data to the frame memory 111 for storage.

The first coding section 112 performs entropy coding on the quantization coefficient generated by the transformation and quantization section 108 and the first prediction information input from the first prediction section 107 to generate first coded data. Although a method for entropy coding is not particularly limited, Golomb coding, arithmetic coding, Huffman coding, etc. can be used. The generated first coded data is input to the integrally coding section 116.

Next, an image data coding operation in the case where lossless coding is selected by the lossless-coding-block determination section 106 will be described.

The second prediction section 113 performs prediction in units of blocks and divides the individual blocks into subblocks of a size equal to or smaller than the blocks as necessary. A second prediction error is generated as the difference between the input block-by-block image and the predicted image and is input to the second image reproduction section 114 and the second coding section 115.

The second image reproduction section 114 generates a predicted image on the basis of the second prediction information input from the second prediction section 113 with reference to the frame memory 111 as appropriate. The second image reproduction section 114 reproduces image data from the generated predicted image and the second prediction error input from the second prediction section 113 and inputs the reproduced image data to the frame memory 111 for storage.

The second coding section 115 performs entropy coding on the second prediction information and the second prediction error input from the second prediction section 113 to generate second coded data. Although a method for entropy coding is not particularly limited, Golomb coding, arithmetic coding, Huffman coding, etc. can be used. The generated second coded data is input to the integrally coding section 116.

The integrally coding section 116 codes information generated before the coding operation to generate various codes and multiplexes the codes, the first coded data generated by the first coding section 112, the second coded data generated by the second coding section 115, and so on to form a bit stream. Specifically, the lossless coding information output from the lossless-coding determination section 102, the quantization control sizes output from the quantization-control-size determination section 103, and the quantization parameters output from the quantization control section 104 are coded, and various codes are generated. The finally generated bit stream is output through the terminal 117 to the outside.

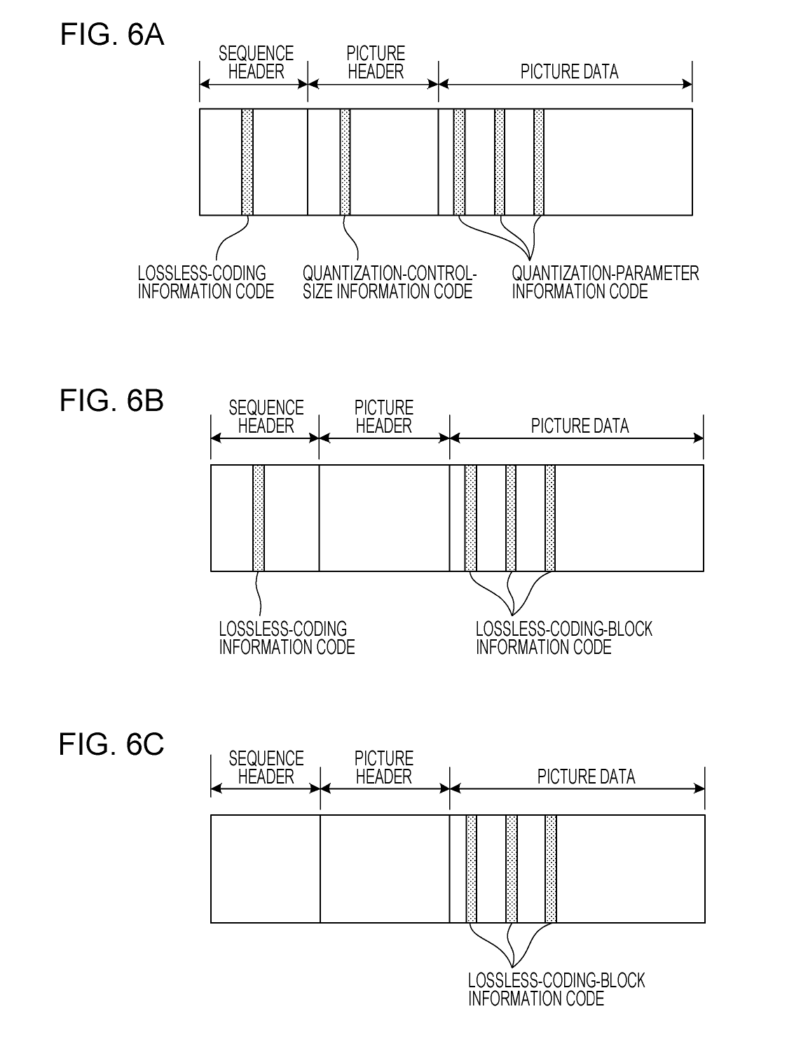

FIG. 6A shows an example of the bit stream including the coded lossless coding information, quantization control size, and quantization parameter. The lossless coding information and the quantization parameter are included in the sequence header or the picture header as a lossless-coding information code and a quantization-control-size information code, respectively. Specifically, the lossless-coding information code is a one-bit flag. When the lossless-coding information code is 1, it is possible that the bit stream includes a lossless coding block. When the lossless-coding information code is 0, there is no possibility that the bit stream includes a lossless coding block. Furthermore, assuming that quantization-control-size information is the difference between the block size and the quantization control size, expressed as an index, the quantization-control-size information code is coded quantization-control-size information. For example, when the block size is 64*64 pixels, and the quantization control size is also 64*64 pixels, the quantization-control-size information is set to 0, and when the quantization control size is 32*32 pixels, the quantization-control-size information is set to 1. Similarly, when the block size is 32*32 pixels, and the quantization control size is also 32*32 pixels, the quantization-control-size information is set to 0, and when the quantization control size is 8*8 pixels, the quantization-control-size information is set to 2. Of course, the relationship between the quantization control size and the quantization-control-size information is not limited thereto; the quantization control size may be directly indexed. For example, when the quantization control size is 32*32 pixels, the quantization-control-size information can be set to 1 irrespective of the block size. Although a coding method for the quantization-control-size information is not particularly limited, Golomb coding, Huffman coding, and so on can be used. For quantization parameters, quantization-parameter information codes are included, in units of the quantization control sizes, in the bit stream. In the first embodiment, in the case where the lossless-coding information code is 1, and the quantization parameter in units of quantization control sizes calculated from the quantization-parameter information code is a specific value, all subblocks included in units of the quantization control sizes are subjected to lossless coding. Otherwise, all subblocks included in units of the quantization control sizes are subjected to lossy coding. For example, in H.264, since the quantization control size is always 16*16 pixels, which is equal to the block size, the target block is subjected to lossless coding in the case where the lossless-coding information code is 1, and the quantization parameter is 0.

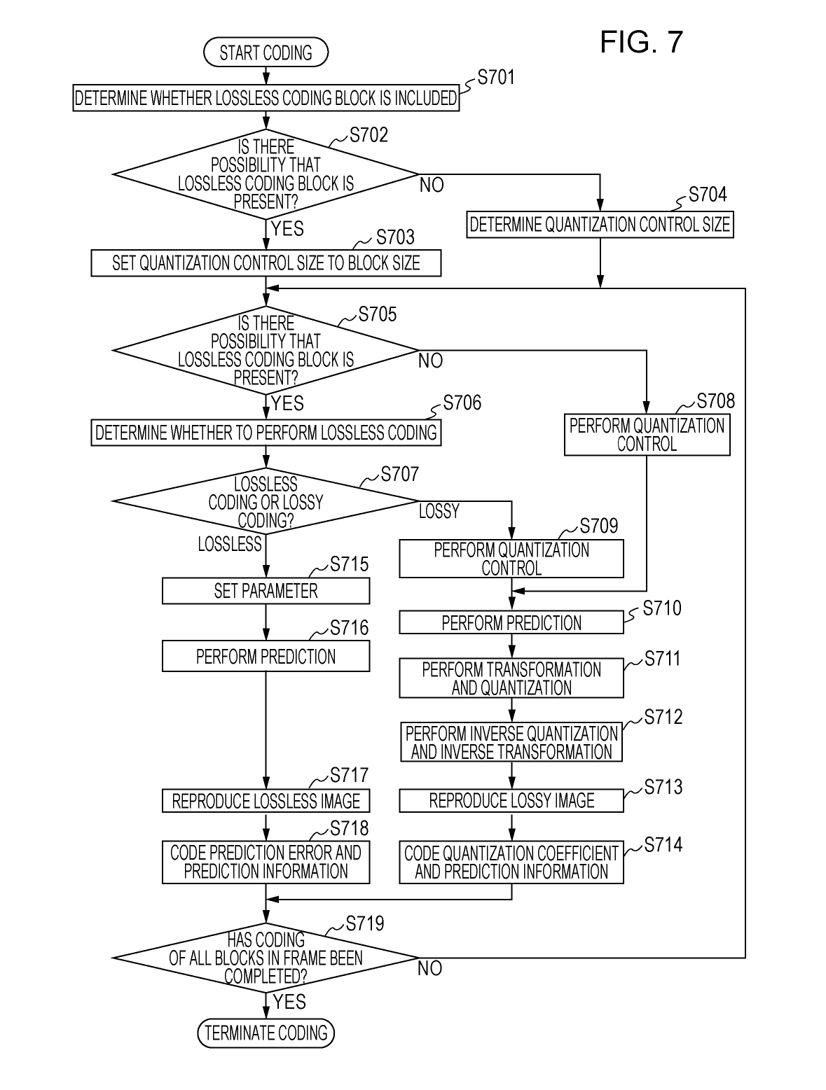

FIG. 7 is a flowchart showing an image coding process in the image coding apparatus according to the first embodiment. First, in step S701, the lossless-coding determination section 102 determines whether there is a possibility that an input frame includes a lossless coding block and sets the information as lossless coding information. This information is coded by the integrally coding section 116.

In step S702, the image coding apparatus makes a determination based on the lossless coding information generated in step S701. If there is a possibility that a lossless coding block is present, the process proceeds to step S703, and if there is no possibility, the process proceeds to step S704.

In step S703, the quantization-control-size determination section 103 determines a quantization control size which is the smallest unit for controlling quantization. In this step, the quantization control size is set to be equal to the block size. The information on the quantization control size is also coded by the integrally coding section 116.

In step S704, the quantization-control-size determination section 103 determines a quantization control size which is the smallest unit for controlling quantization. In this step, there is no particular limit for the quantization control size to be determined; the quantization control size is set to a size equal to or smaller than the block size. The information on the set quantization control size is coded by the integrally coding section 116.

In step S705, the image coding apparatus determines whether there is a possibility that a lossless coding block is present on the basis of the lossless coding information generated in step S701. If there is a possibility, the process proceeds to step S706, and if there is no possibility, the process proceeds to step S708.

In step S706, the block dividing section 105 cuts the input image data into a plurality of blocks, and the lossless-coding-block determination section 106 determines whether the individual blocks are subjected to lossless coding or lossy coding and sets the information as lossless coding block information.

In step S707, the image coding apparatus determines whether the coding target block is to be subjected to lossless coding. If lossless coding is to be performed, the process proceeds to step S715, and lossy coding is to be performed, the process proceeds to step S709.

In step S708, the block dividing section 105 cuts the input image data into a plurality of blocks, and the quantization control section 104 determines quantization parameters in the coding target block in units of quantization control sizes. There is no limitation to control of the quantization parameters in this step. The integrally coding section 116 codes the determined quantization parameters.

In step S709, the quantization control section 104 determines the quantization parameters in the coding target block in units of quantization control sizes. In this step, the quantization control section 104 sets the quantization parameters to a value other than the above-described specific value. The integrally coding section 116 codes the set quantization parameters.

In step S710, the first prediction section 107 performs prediction in units of blocks and divides the individual blocks into subblocks of a size equal to or smaller than the blocks to generate a predicted image and the first prediction information. Furthermore, the first prediction section 107 calculates the first prediction error from the input image data and the predicted image.

In step S711, the transformation and quantization section 108 orthogonally transforms the first prediction error calculated in step S710 to generate a transformation coefficient and furthermore quantizes the transformation coefficient on the basis of the quantization parameter determined in step S708 or 5709 to generate a quantization coefficient.

In step S712, the inverse-quantization and inverse-transformation section 109 inversely quantizes the quantization coefficient generated in step S711 on the basis of the quantization parameter determined in step S708 or S709 and further orthogonally transforms the quantization coefficient to reproduce the first prediction error.

In step S713, the first image reproduction section 110 generates a predicted image on the basis of the first prediction information generated in step S710 and further reproduces image data from the generated predicted image and the first prediction error reproduced in step S712.

In step S714, the first coding section 112 codes the first prediction information generated in step S710 and the quantization coefficient generated in step S711 to generate first coded data. Furthermore, the integrally coding section 116 generates a bit stream including the other coded data.

On the other hand, in step S715, the quantization control section 104 sets the quantization parameter in the coding target block to the above-described specific value. The integrally coding section 116 codes the set quantization parameter.

In step S716, the second prediction section 113 performs prediction in units of blocks and divides the individual block into subblocks of a size equal to or smaller than the blocks as necessary to generate second prediction information and a predicted image. Furthermore, the second prediction section 113 calculates a second prediction error from the input image data and the predicted image data.

In step S717, the second image reproduction section 114 generates a predicted image on the basis of the second prediction information generated in step S716. Furthermore, the second image reproduction section 114 reproduces image data from the generated predicted image and the second prediction error generated in step S716.

In step S718, the second coding section 115 codes the second prediction information and the second prediction error generated in step S716 to generate second coded data. Furthermore, the integrally coding section 116 generates a bit stream including the other coded data.

In step S719, the image coding apparatus determines whether coding of all the blocks has been completed, in which if the coding has been completed, the process is terminated, and if the coding has not been completed, the process returns to step S705 for the next block.

The above configuration and operation can prevent, particularly in the case where there is a possibility that the target block includes a lossless coding block in step S703, lossless coding and lossy coding from being mixed in the block by setting the quantization control size to a block size. Since the process of quantization and transformation or the process of inverse quantization and transformation can be separated in units of blocks, pipeline implementation when lossless coding is used can be made easy. Furthermore, the first embodiment also has an advantage of reducing the process of the quantization-control-size determination section 103 because, in the case where there is a possibility that the target block includes a lossless coding block, the quantization control size is fixed to the block size.

Furthermore, although the first embodiment is provided with the first prediction section and the first image reproduction section for lossy coding and the second prediction section and the second image reproduction section for lossless coding, a single prediction section and a single image reproduction section may perform lossless coding and lossy coding processes. Although the first embodiment is provided with the separate first coding section and second coding section, a single coding section may perform lossless and lossy coding processes. Furthermore, since the image data, which is an output of the second image reproduction section 114, is the same as the input image data, the input image data may be input to the frame memory 111 without particularly providing the second image reproduction section 114. Similarly, the operation of step S717 may be omitted.

Furthermore, for the method for identifying a lossless coding block, the first embodiment uses a combination of the flag of lossless coding information in a sequence header and a quantization parameter at the block level, the coding method is not limited thereto. A flag indicating lossless coding may be coded at the block level or the flag indicating lossless coding may be included in the header at the sequence level or the picture level.

The configuration of the bit stream is not limited thereto. For example, the bit stream may be coded as shown in FIG. 6B. FIG. 6B shows an example in which the sequence header includes a lossless-coding information code, and when the lossless-coding information code is 1, lossless-coding-block information codes indicating whether the individual blocks are subjected to lossless coding are included in units of blocks in addition to the quantization-parameter information codes. This configuration provides an advantage of reducing the amount of codes in a bit stream including only lossy coding blocks. This configuration also has an advantage of eliminating the need for transmission of quantization parameters to lossless coding blocks.

Alternatively, the bit stream may be coded as shown in FIG. 6C. FIG. 6C shows an example in which no lossless-coding information code is included in units of sequences and in which a lossless-coding-block information code indicating whether the block is subjected to lossless coding is included in all the blocks. This configuration allows discrimination between a lossless coding block and a lossy coding block to be made without decoding the quantization parameters. This configuration has an advantage of facilitating separation of processes in units of blocks. Furthermore, for lossless coding blocks, this configuration eliminates the need for transmission of quantization parameters. Furthermore, this configuration allows the lossless-coding determination section 102 to be omitted.

Furthermore, although the lossless-coding determination section 102 is configured to determine whether there is a possibility that a lossless coding block is included in a frame, it may be configured to determine whether there is a possibility that a lossless coding block is included in a sequence including one or more frames. Similarly, the lossless coding information may be information indicating whether there is a possibility that a lossless coding block is included in a sequence.

In the first embodiment, although the lossless coding determination is made separately from the lossless coding block determination, the present invention is not limited thereto. After lossless coding block determination is made for all the blocks of an image or a sequence, lossless coding determination on the image or sequence may be made using the result.

### Second Embodiment

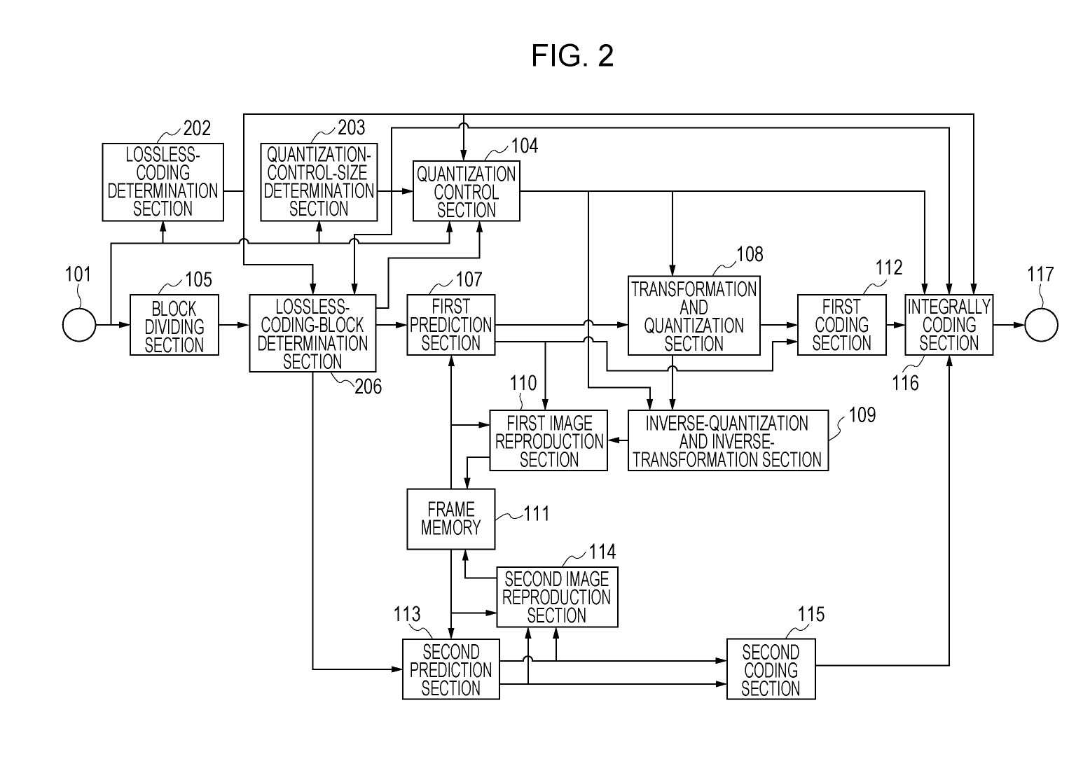

FIG. 2 is a block diagram showing an image coding apparatus of a second embodiment. In FIG. 2, components having the same functions as in the first embodiment in FIG. 1 are given the same reference numerals, and descriptions thereof are omitted.

Reference numeral 202 denotes a lossless-coding determination section, which determines whether there is a possibility that a lossless coding block in which lossless coding is to be performed is included in a frame, similarly to the lossless-coding determination section 102 of the first embodiment.

Reference numeral 203 denotes a quantization-control-size determination section, which determines a subblock size serving as a unit for controlling a quantization parameter, similarly to the quantization-control-size determination section 103 of the first embodiment.

Reference numeral 206 denotes a lossless-coding-block determination section, which determines whether a target block is to be subjected to lossless coding or lossy coding in units of divided blocks, similarly to the lossless-coding-block determination section 106 of the first embodiment.

An image coding operation of the image coding apparatus will be described hereinbelow.

Although the lossless-coding determination section 202 determines whether there is a possibility that an input frame includes a lossless coding block, similarly to the lossless-coding determination section 102 of the first embodiment, a method for determination is not particularly limited. The lossless-coding determination section 202 differs from the lossless-coding determination section 102 of the first embodiment in that it does not output the determined lossless coding information to the quantization-control-size determination section 203.

The quantization-control-size determination section 203 determines a quantization control size, which is the smallest unit for quantization control. A method for determining the quantization control size is not limited similarly to the quantization-control-size determination section 103 of the first embodiment. One of differences from the quantization-control-size determination section 103 of the first embodiment is that it does not receive lossless coding information from the lossless-coding determination section 202. Another difference is that the determined quantization control size is output also to the lossless-coding-block determination section 206.

The lossless-coding-block determination section 206 determines whether the individual target blocks are to be subjected to lossless coding or lossy coding, similarly to the lossless-coding-block determination section 106 of the first embodiment. However, the lossless-coding-block determination section 206 differs from the lossless-coding-block determination section 106 of the first embodiment in that in the case where the quantization control size input from the quantization-control-size determination section 203 is smaller than the block size, the lossless-coding-block determination section 206 does not select lossless coding. The information whether the target block is to be subjected to lossless coding or lossy coding is output to the quantization control section 104 as lossless coding block information.

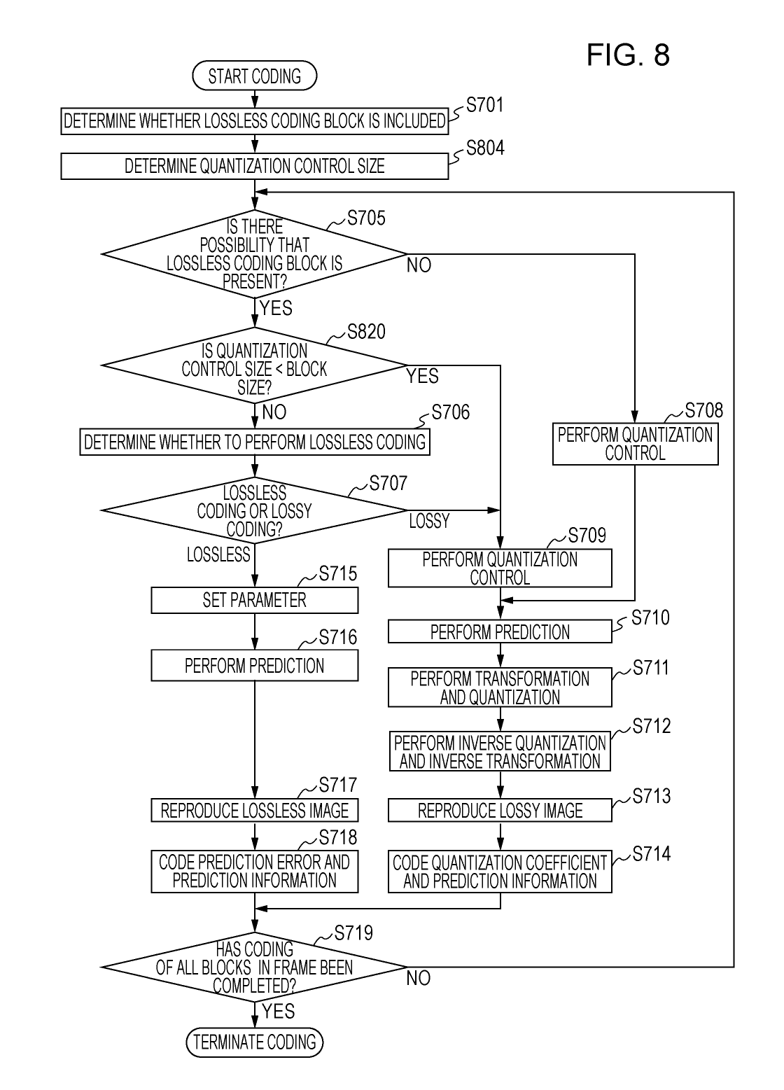

FIG. 8 is a flowchart showing an image coding process in the image coding apparatus according to the second embodiment. Processes for the same functions as in the first embodiment in FIG. 7 are given the same reference numerals, and descriptions thereof are omitted.

In step S804, the quantization-control-size determination section 203 determines a quantization control size, which is the smallest unit for quantization control, irrespective of the lossless coding information. As in step S704 of the first embodiment, the quantization control size to be determined is not particularly limited in step S804. Information on the quantization control size is coded by the integrally coding section 116.

In step S820, the image coding apparatus makes a determination based on the quantization control size determined in step S802. If the quantization control size is smaller than the block size, the process proceeds to step S709, and if No, the process proceeds to step S706.

The above configuration and operation can prevent, particularly in the case where the quantization control size is smaller than the block size in step S820, lossless coding and lossy coding from being mixed in the individual blocks by not selecting lossless coding. This can facilitate pipeline implementation when lossless coding is used. Furthermore, in the second embodiment, since determination of the quantization control size is given priority over determination of lossless coding, it is also possible to perform implementation in which determination of the quantization control size is made first and then determination of lossless coding is made.

Furthermore, since it is possible to determine whether the quantization block size is smaller than the block size in units of pictures, quantization for lossy coding using a specific value cannot be performed; however, it is also possible to have a configuration in which there is no need for a lossless-coding information code in a sequence header.

### Third Embodiment

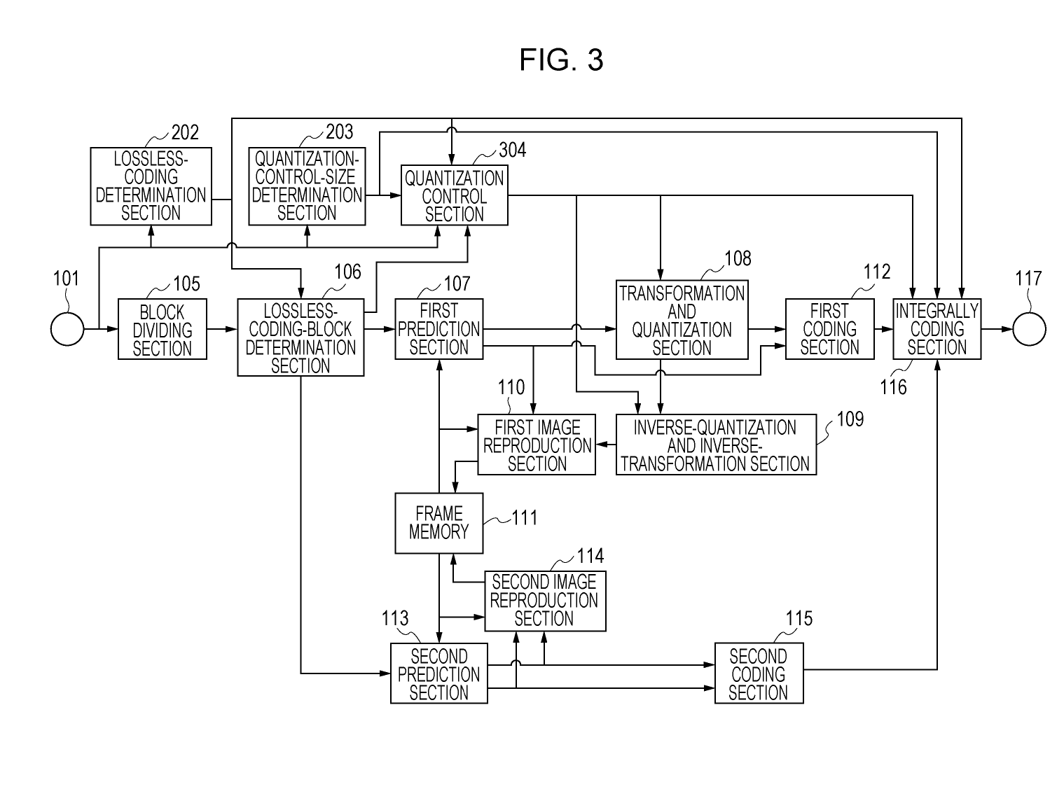

FIG. 3 is a block diagram showing an image coding apparatus of a third embodiment. In FIG. 3, components having the same function as in the second embodiment in FIG. 3 are given the same reference numerals, and descriptions thereof are omitted.

Reference numeral 304 denotes a quantization control section, which determines quantization parameters in a frame in units of the quantization control size, similarly to the quantization control section 104 of the first embodiment. However, a method for generating quantization parameters for a lossless coding block differs from that of the quantization control section 104 of the first embodiment.

An image coding operation of the image coding apparatus will be described hereinbelow. The quantization control section 304 receives a quantization control size from the quantization-control-size determination section 203 and determines the quantization parameters of the individual subblocks in the block, in units of the quantization control size. A method for determining quantization parameters is not particularly limited. However, in the case where the determination result of the lossless-coding-block determination section 106 shows that the block that the target subblock belongs to is a lossless coding block, the quantization control section 304 sets the first quantization parameter of the quantization control size in the block to 0. In the other cases, in the case where the lossless coding information shows a possibility that the block is a lossless coding block, the quantization control section 304 sets a value other than 0, and in the case where there is no possibility, the value is not particularly limited. The quantization parameters to be set are not limited thereto provided that it is shown that the target block is a lossless coding block by a combination of a quantization parameter of the set specific value and lossless coding information. The determined quantization parameters are input to the transformation and quantization section 108, the inverse-quantization and inverse-transformation section 109, and the integrally coding section 116.

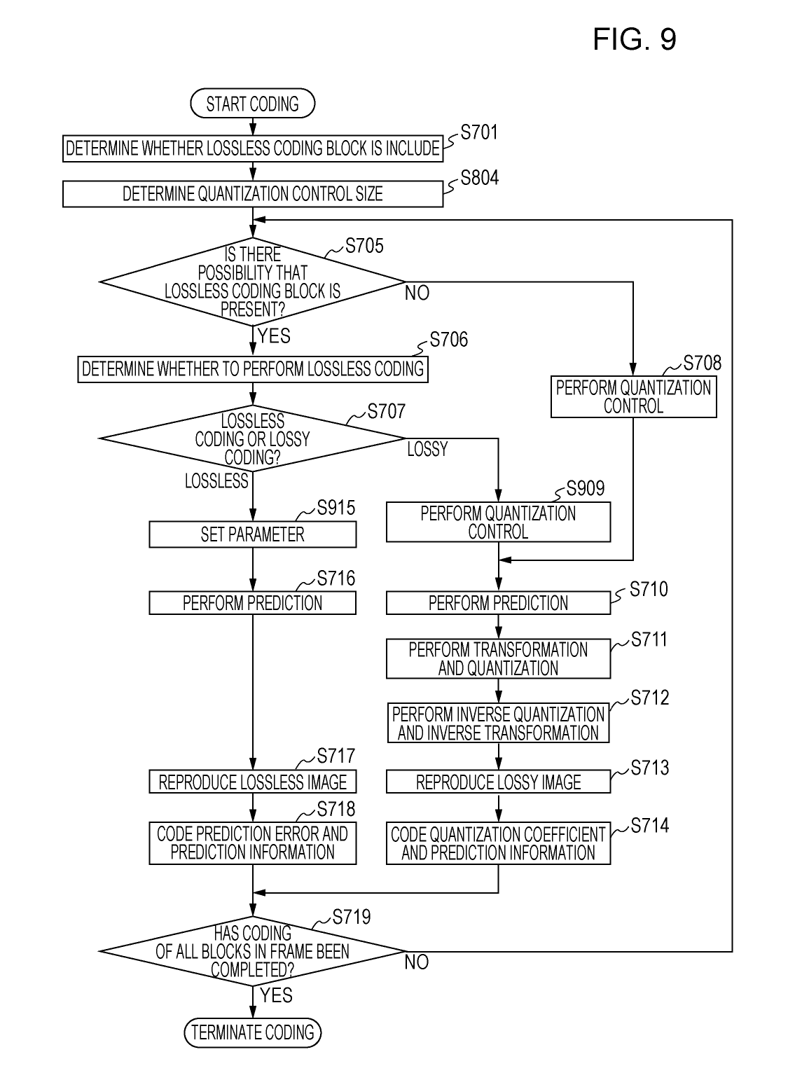

FIG. 9 is a flowchart showing an image coding process in the image coding apparatus according to the third embodiment. Processes for the same functions as in the second embodiment in FIG. 8 are given the same reference numerals, and descriptions thereof are omitted.

In step S707, the image coding apparatus determines whether the coding target block is to be subjected to lossless coding. If lossless coding is to be performed, the process proceeds to step S915, and lossy coding is to be performed, the process proceeds to step S909.

In step S909, the quantization control section 304 determines quantization parameters in the coding target block in units of quantization control sizes. The quantization control section 304 sets the first quantization parameter in the coding target block in units of quantization control sizes to a value other than the above-described specific value. There is no limitation to control of the second quantization parameter and subsequent parameters in units of quantization control sizes.

On the other hand, in step S915, the quantization control section 104 sets the first quantization parameter of the coding target block in units of quantization control sizes to the above-described specific value.

The above configuration and operation can prevent, particularly in steps S909 and S915, lossless coding and lossy coding from being mixed in the target coding block by making the determination using the first quantization parameter in the coding target block. This can facilitate pipeline implementation when lossless coding is used. Furthermore, the third embodiment has an advantage that there is no need to add particular limitation to the process of determining the quantization control size and the lossless coding block information.

In the third embodiment, although the first quantization parameter is set to 0 in the case where the block is a lossless coding block, it is not limited to this value; another specific value may be separately defined.

### Fourth Embodiment

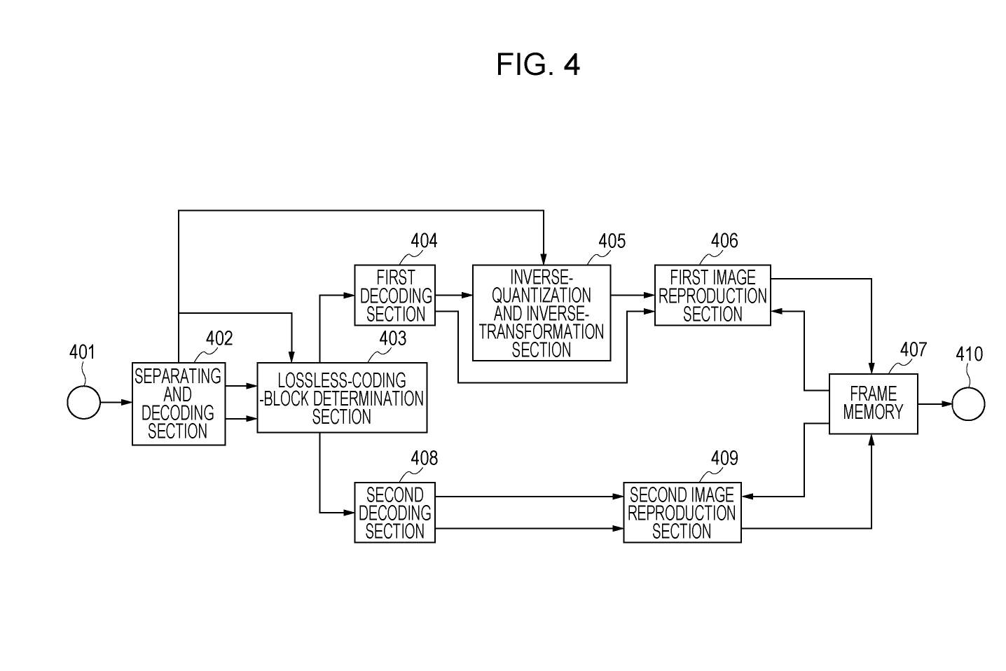

FIG. 4 is a block diagram showing an image decoding apparatus of a fourth embodiment of the present invention. The fourth embodiment will be described using decoding of the coded data generated in the first and second embodiments as an example.

Reference numeral 401 denotes a terminal to which a coded bit stream is input. Reference numeral 402 denotes a separating and decoding section, which separates coded data concerning information on the decoding process and coefficients from the bit stream and decodes coded data present at the header of the bit stream. Reference numeral 403 denotes a lossless-coding-block determination section, which determines whether the decoding target block is subjected to lossless coding in units of blocks and selects a destination of the input coded data. Reference numeral 404 denotes a first decoding section, which decodes the first coded data output from the lossless-coding-block determination section 403 to reproduce the quantization coefficients and the first prediction information. Reference numeral 405 denotes an inverse-quantization and inverse-transformation section, which inversely quantizes the quantization coefficients on the basis of the input quantization parameters to obtain transformation coefficients and further inversely orthogonally transforms the transformation coefficients to reproduce the first prediction error, similarly to the inverse-quantization and inverse-transformation section 109 in FIG. 1. Reference numeral 407 denotes a frame memory, which stores the image data of the reproduced picture. Reference numeral 406 denotes a first image reproduction section. The first image reproduction section 406 generates predicted image data on the basis of the input first prediction information with reference to the frame memory 407 as appropriate, similarly to the first image reproduction section 110 in FIG. 1, generates reproduced image data from the predicted image data and the first prediction error reproduced by the inverse-quantization and inverse-transformation section 405, and outputs the reproduced image data. Reference numeral 408 denotes a second decoding section. The second decoding section 408 decodes the second coded data output from the lossless-coding-block determination section 403 to reproduce the second prediction error and the second prediction information. Reference numeral 409 denotes a second image reproduction section. The second image reproduction section 409 generates predicted image data for losslessly coded blocks on the basis of the input second prediction information with reference to the frame memory 407 as appropriate, generates reproduced image data from the predicted image data and the input second prediction error, and outputs the reproduced image data, similarly to the second image reproduction section 114 in FIG. 1. Reference numeral 410 denotes a terminal, from which the image data is output to the outside.

An image decoding operation of the above image decoding apparatus will be described hereinbelow. In the fourth embodiment, the bit stream generated in the first and second embodiments is decoded.

In FIG. 4, the bit stream input to the terminal 401 is input to the separating and decoding section 402.

The separating and decoding section 402 separates coded data about information concerning the decoding process and coefficients from the bit stream and decodes coded data present at the header of the bit stream and coded data necessary for decoding the quantization parameters. Specifically, the separating and decoding section 402 reproduces the lossless coding information and the quantization control size. In the fourth embodiment, the separating and decoding section 402 first extracts the lossless-coding information code from the sequence header of the bit stream shown in FIG. 6A and codes the code, and further extracts the quantization-control-size information code from the picture header, and decodes the code. The separating and decoding section 402 further decodes the quantization-parameter information codes included in the picture data on the basis of the quantization-control-size information code to reproduce the quantization parameters. The lossless coding information and the quantization parameters are input to the lossless-coding-block determination section 403 together with the remaining undecoded picture data. The quantization parameters are input also to the inverse-quantization and inverse-transformation section 405.

The lossless-coding-block determination section 403 determines whether the target block is subjected to lossless coding or lossy coding in units of blocks depending on the combination of the lossless coding information and the quantization parameter. Specifically, in the case where the lossless coding information indicates a possibility that the target block includes a lossless coding block, the quantization control size is equal to the block size, and the quantization parameter exhibits a specific value, the lossless-coding-block determination section 403 determines that the decoding target block is subjected to lossless coding. In other words, in the fourth embodiment, in the case where the lossless coding information is 1, the quantization-control-size information is 0, and the quantization parameter has a specific value, it is determined that the block is a lossless coding block. Otherwise, it is determined that the block is a lossy coding block.

For the bit stream generated in the first embodiment, in the case where the lossless coding information is 1, the quantization-control-size information is always 0, and control of the quantization parameters is performed only in units of blocks. Thus, switching between lossless coding and lossy coding occurs only in units of blocks, so that lossless coding and lossy coding are not mixed in the same block.

On the other hand, for the bit stream generated in the second embodiment, in the case where lossless coding information is 1, and the quantization-control-size information is other than 0, the quantization parameters do not have the specific value indicating lossless coding. Thus, in the case where the quantization control size is smaller than the block size, the target block is always subjected to lossy coding, so that lossless coding and lossy coding are not mixed in the same block, as in the bit stream generated in the first embodiment.

Next, the block-by-block coded data of the input picture data is output to the subsequent stage. For a lossy coding block, the first coded data is separated from the picture data and is output to the first decoding section 404. For a lossless coding block, the second coded data is separated from the picture data and is output to the second decoding section 408.

The first decoding section 404 decodes the first coded data to reproduce the quantization coefficients and the first prediction information. The reproduced quantization coefficients are output to the inverse-quantization and inverse-transformation section 405, and the reproduced first prediction information is output to the first image reproduction section 406.

The inverse-quantization and inverse-transformation section 405 inversely quantizes the quantization coefficients input from the first decoding section 404 on the basis of the quantization parameters input from the separating and decoding section 402 to reproduce the orthogonal transformation coefficients and further inversely orthogonally transforms the orthogonal transformation coefficients to reproduce the first prediction error. The reproduced prediction error is input to the first image reproduction section 406.

The first image reproduction section 406 generates a predicted image on the basis of the first prediction information input from the first decoding section 404 with reference to the frame memory 407 as appropriate. The first image reproduction section 406 reproduces image data from the predicted image and the first prediction error input from the inverse-quantization and inverse-transformation section 405 and inputs the image data to the frame memory 407 for storage. The stored image data is used as reference for prediction.

On the other hand, the second decoding section 408 decodes the second coded data to reproduce the second prediction error and the second prediction information. The reproduced prediction error and second prediction information are output to the second image reproduction section 409.

The second image reproduction section 409 generates a predicted image on the basis of the second prediction information input from the second decoding section 408 with reference to the frame memory 407 as appropriate. The second image reproduction section 409 reproduces image data from the predicted image and the second prediction error input from the second decoding section 408 and inputs the image data to the frame memory 407 for storage.

The image data stored in the frame memory 407 is finally output to the outside from the terminal 410.

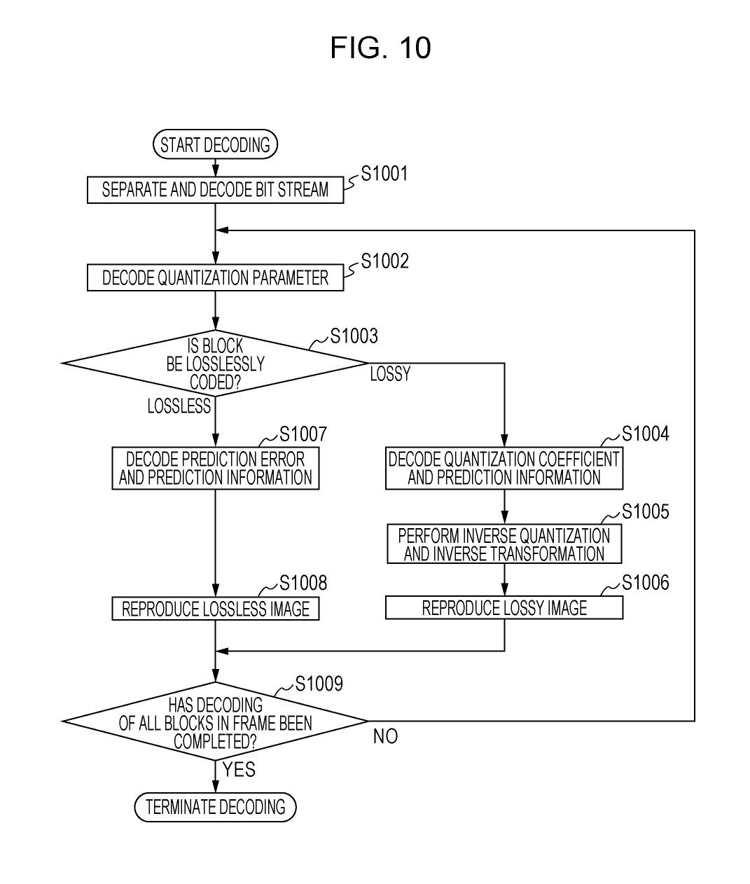

FIG. 10 is a flowchart showing the image decoding process of the image decoding apparatus according to the fourth embodiment.

First, in step S1001, the separating and decoding section 402 separates coded data concerning information on the decoding process and coefficients from the bit stream and decodes coded data present at the header of the bit stream. Specifically, the separating and decoding section 402 reproduces the lossless coding information and the quantization control size whose codes are present in the header.

In step S1002, the separating and decoding section 402 reproduces the quantization parameter of the decoding target block from the picture data in units of quantization control sizes.

In step S1003, the lossless-coding-block determination section 403 determines whether the decoding target block is subjected to lossless coding or lossy coding depending on the combination of the lossless coding information and the quantization control size reproduced in step S1001 and the quantization parameter. Specifically, in the case where the lossless coding information indicates a possibility that the target block includes a lossless coding block, the quantization control size is equal to the block size, and the quantization parameter exhibits a specific value, the lossless-coding-block determination section 403 determines that the decoding target block is subjected to lossless coding. Otherwise, the lossless-coding-block determination section 403 determines that the decoding target block is subjected to lossy coding. If the decoding target block is subjected to lossless coding, the process proceeds to step S1007, and if subjected to lossy coding, the process proceeds to step S1004.

In step S1004, the first decoding section 404 decodes the first coded data separated by the separating and decoding section 402 to reproduce the quantization coefficients and the first prediction information.

In step S1005, the inverse-quantization and inverse-transformation section 405 inversely quantizes the quantization coefficients in units of blocks to obtain transformation coefficients and further inversely orthogonally transforms the transformation coefficients to reproduce the first prediction error.

In step S1006, the first image reproduction section 406 generates a predicted image on the basis of the first prediction information generated in step S1004. The first image reproduction section 406 further reproduces image data from the generated predicted image and the first prediction error reproduced in step S1005.

On the other hand, in step S1007, the second decoding section 408 decodes the second coded data separated by the separating and decoding section 402 to reproduce a second prediction error and second prediction information.

In step S1008, the second image reproduction section 409 generates a predicted image on the basis of the second prediction information reproduced in step S1007. The second image reproduction section 409 further reproduces image data from the generated predicted image and the second prediction error reproduced in step S1007.

In step S1009, the image decoding apparatus determines whether decoding of all the blocks has been completed, where if decoding has been completed, the decoding process is terminated, and if decoding has not been completed, the decoding process returns to step S1002 for the next block.

The above configuration and operation allow the bit stream in which lossy coding and lossless coding are not mixed in the same block, generated in the first and second embodiments, to be decoded. This can enhance the independency of the process, thus increasing the ease of pipeline implementation of the decoding apparatus.

Furthermore, although the fourth embodiment is provided with the first image reproduction section and the second image reproduction section independently for decoding a lossy coding block and for decoding a lossless coding block, respectively, a single image reproduction section may perform decoding of lossless and lossy coding blocks. Similarly, although the fourth embodiment includes the independent first and second decoding sections, a single decoding section may perform decoding of lossless and lossy coding blocks.

Although the fourth embodiment shows decoding of the bit stream shown in FIG. 6A, the configuration of a bit stream to be decoded is not limited thereto. For example, a bit stream, as shown in FIG. 6B, may be decoded. FIG. 6B shows an example in which the sequence header includes a lossless-coding information code, and when the lossless-coding information code is 1, lossless-coding-block information codes indicating whether the individual blocks are subjected to lossless coding are included in units of blocks in addition to the quantization-parameter information codes. This configuration allows a bit stream including only lossy coding blocks and having a reduced amount of codes to be decoded.

Alternatively, a bit stream, as shown in FIG. 6C, may be decoded. FIG. 6C shows an example in which no lossless-coding information code is included in units of sequences and in which a lossless-coding-block information code indicating whether the block is subjected to lossless coding is included in all the blocks. This configuration allows a bit stream having an advantage of facilitating discrimination between a lossless coding block and a lossy coding block to be decoded. Furthermore, for lossless coding blocks, this configuration has an advantage of eliminating the need for quantization parameters, thus omitting the process of decoding quantization parameters.

Although the lossless coding information of the fourth embodiment is information indicating whether there is a possibility that a lossless coding block is included in a sequence including one or more frames, it may be information indicating whether there is a possibility that a lossless coding block is included in a frame.

### Fifth Embodiment

An image decoding apparatus of a fifth embodiment has the same configuration as that of the fourth embodiment in FIG. 4. However, the fifth embodiment differs in the operation of the lossless-coding-block determination section 403. Accordingly, decoding other than that performed by the lossless-coding-block determination section 403 is the same as that of the fourth embodiment, and descriptions thereof will be omitted. In the fifth embodiment, decoding of the bit stream generated in the third embodiment will be described.

The lossless-coding-block determination section 403 determines whether the decoding target block is subjected to lossless coding or lossy coding in units of blocks depending on the combination of the input lossless coding information and quantization parameters. Specifically, in the case where the lossless coding information indicates a possibility that the target block includes a lossless coding block, and the first quantization parameter in the block in units of quantization control sizes exhibits a specific value, the lossless-coding-block determination section 403 determines that the decoding target block is subjected to lossless coding. In other words, in the fifth embodiment, in the case where lossless coding information indicates a possibility that the decoding target block includes a lossless coding block, and the first quantization parameter in the block in units of quantization control sizes has a specific value, it is determined that the block is a lossless coding block. Otherwise, it is determined that the block is a lossy coding block.

For the bit stream generated in the third embodiment, in the case where the lossless-coding information code is 1, the determination whether the target block is to be subjected to lossless coding or lossy coding in units of blocks depends on the first quantization parameter in the block in units of quantization control sizes, irrespective of the quantization control size. In the case where the lossless-coding information code is 1, and the first quantization parameter in the block in units of quantization control sizes is a specific value, the entire target block is regarded as a lossless coding block, otherwise the entire target block is regarded as a lossy coding blocks. Thus, lossless coding and lossy coding are not mixed in the same block.

Next, the block-by-block coded data of the picture data is output to the subsequent stage. For a lossy coding block, the first coded data is separated and is output to the first decoding section 404. For a lossless coding block, the second coded data is separated and is output to the second decoding section 408.

A flowchart for the image decoding process of the fifth embodiment is the same as that of the fourth embodiment in FIG. 10. However, the fifth embodiment differs in the operation in step S1003. Accordingly, decoding operations other than that in step S1003 are the same as those in the fourth embodiment, and descriptions thereof will be omitted.

In step S1003, the lossless-coding-block determination section 403 determines whether the decoding target block is subjected to lossless coding depending on the combination of the lossless coding information and the quantization parameter reproduced in step S1001. Specifically, in the case where the lossless coding information indicates a possibility that the target block includes a lossless coding block, and the first quantization parameter of the decoding target block in units of quantization control sizes exhibits a specific value, the lossless-coding-block determination section 403 determines that the decoding target block is subjected to lossless coding. If the decoding target block is subjected to lossless coding, the process proceeds to S1007, and if subjected to lossy coding, the process proceeds to S1004.

The above configuration and operation allow a bit stream in which lossy coding and lossless coding are not mixed in the same block, generated in the third embodiment, without particular limitation to the quantization control size, to be decoded. This can facilitate pipeline implementation of the decoding apparatus.

### Sixth Embodiment

The above embodiments have been described assuming that the processing units shown in FIGS. 1 to 4 are configured as hardware. As an alternative, the processes performed by the processing units shown in FIGS. 1 to 4 may be achieved using a computer program.

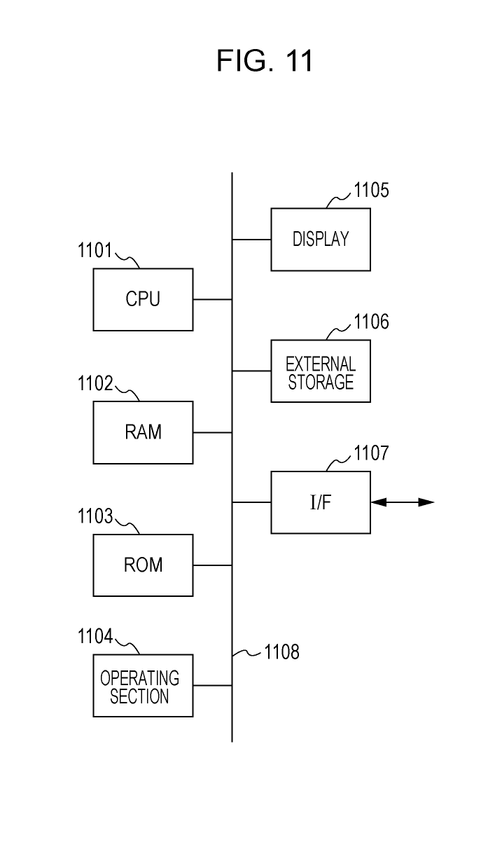

FIG. 11 is a block diagram showing an example of the configuration of computer hardware that can be applied to the image display apparatuses according to the above embodiments.

A CPU 1101 controls the entire computer by using a computer program and data stored in a RAM 1102 and a ROM 1103 and implements the above processes to be performed by the image processing apparatuses according to the above embodiments. That is, the CPU 1101 functions as the processing units shown in FIGS. 1 to 4.

The RAM 1102 has an area for temporarily storing a computer program and data loaded from an external storage 1106 and data acquired from the outside via an interface (I/F) 1107. The RAM 1102 also has a work area that the CPU 1101 uses when executing various processes. That is, the RAM 1102 can be used as a frame memory or can provide other various areas as appropriate.

The ROM 1103 stores set data, a boot program, and so on of the computer. An operating section 1104 includes a keyboard and a mouse, which the user of the computer operates to input various instructions to the CPU 1101. A display 1105 displays the result of processing by the CPU 1101. An example of the display 1105 is a liquid crystal display.

The external storage 1106 is a mass information storage typified by a hard disk drive. The external storage 1106 stores an operating system (OS) and a computer program for causing the CPU 1101 to implement the functions of the components shown in FIGS. 1 to 4. The external storage 1106 may also store various items of image data to be processed.

The computer program and data stored in the external storage 1106 are loaded on the RAM 1102 as appropriate under the control of the CPU 1101 and are to be processed by the CPU 1101. The I/F 1107 can connect to a network, such as a LAN and the Internet, and other devices, such as a projector and a display. The computer can acquire or send out various information via the I/F 1107. Reference numeral 1108 denotes a bus that connects the above components.

The operations of the above components, which have been described in the above flowcharts, are centrally controlled by the CPU 1101.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-092215, filed Apr. 13, 2012, which is hereby incorporated by reference herein in its entirety.

What is claimed is:

1. A method for coding an image to generate an image bit stream, the method comprising:
a first coding step of coding an image in units of blocks in a first coding mode in which quantization is performed;
a second coding step of coding an image in units of blocks in a second coding mode in which quantization is not performed;
a determination step of determining which of the first coding mode or the second coding mode is used to code the image in units of blocks; and
an integrally coding step of, in the case where it is determined in the determination step that coding is performed using the second coding step, switching between the first coding step and the second coding step in units of blocks and coding information indicating that switching is performed in units of blocks as block-by-block mode-switching information.

2. The method according to claim 1, wherein
the first coding step comprises:
a first prediction step of performing prediction on the image divided into blocks to generate a first prediction error;
a transformation and quantization step of orthogonally transforming the first prediction error to generate a transformation coefficient and further quantizing the transformation coefficient to generate a quantization coefficient; and
a quantization-coefficient coding step of coding the quantization coefficient, and
the second coding step comprises:
a second prediction step of performing prediction on the image divided into blocks to generate a second prediction error; and
a prediction-error coding step of coding the second prediction error.

3. The method according to claim 1, further comprising:
a quantization control step of controlling a quantization parameter indicating the degree of quantization in units of quantization subblocks that are obtained by dividing the blocks of a size equal to or smaller than that of the blocks,
wherein, in the integrally coding step, second coding information indicating a possibility that the image bit stream includes a block coded in the second coding mode and minimum-quantization-control-unit information indicating the minimum unit of the quantization subblocks in the quantization control step are coded as the block-by-block mode-switching information.

4. The method according to claim 3, wherein in the case where the second coding information indicates a possibility that the bit stream includes a block coded in the second coding mode, in the quantization control step, quantization control is not performed in a unit smaller than the block, and in the integrally coding step, information indicating that the minimum-quantization-control-unit information is equal to the size of the block is coded as the block-by-block mode-switching information.

5. The method according to claim 3, wherein in the case where the minimum-quantization-control-unit information is smaller than the size of the block, it is determined in the determination step that only the first coding mode is to be used.

6. The method according to claim 3, wherein, in the integrally coding step, lossless coding block information indicating whether the coding target block is coded in the first coding mode or in the second coding mode is coded as a combination of the second coding information and the quantization parameter.

7. The method according to claim 6, wherein whether the coding target block is coded in the first coding mode or in the second coding mode is indicated by a combination of the second coding information and the first quantization parameter of the block.

8. A method for decoding an image bit stream to reproduce an image, the method comprising:
a first decoding step of decoding a block coded in a first coding mode in which inverse quantization is performed;
a second decoding step of decoding a block coded in a second coding mode in which inverse quantization is not performed;
a separating and decoding step of decoding a bit stream to decode information indicating that switching between first coding and second coding is performed in units of blocks as block-by-block mode-switching information; and
a determination step of switching between the first decoding step and the second decoding step in units of blocks.

9. The method according to claim 8, wherein
the first decoding step comprises:
a quantization-coefficient decoding step of decoding coded data of a block coded in the first coding mode to reproduce a quantization coefficient;
an inversely quantizing and inversely transforming step of inversely quantizing the quantization coefficient to reproduce a transformation coefficient and further inversely orthogonally transforming the transformation coefficient to reproduce a first prediction error; and
a first reconstructing step of generating a first reproduced image from the reproduced first prediction error and the result of prediction;
the second decoding step comprises:
a prediction-error decoding step of decoding coded data of a block coded in the second coding mode to reproduce a second prediction error; and
a second reconstructing step of generating a second reproduced image from the reproduced second prediction error and a generated predicted image.

10. The method according to claim 8, wherein, in the separating and decoding step, second coding information indicating a possibility that the image bit stream includes a block coded in the second coding mode and minimum-quantization-control-unit information indicating the minimum unit of a quantized subblock, the minimum unit being a unit in which a quantization parameter indicating the degree of quantization is coded, are decoded as the block-by-block mode-switching information.

11. The method according to claim 10, wherein it is determined in the determination step whether a decoding target block is coded in the first coding mode or in the second coding mode depending on a combination of the second coding information and the first quantization parameter of the block, and the decoding process is switched between.

12. An apparatus for coding an image to generate an image bit stream, the apparatus comprising:
a first coding unit configured to code an image in units of blocks in a first coding mode in which quantization is performed;
a second coding unit configured to code an image in units of blocks in a second coding mode in which quantization is not performed;
a determination unit configured to determine which of the first coding mode or the second coding mode is used to code the image in units of blocks; and
an integrally coding unit configured, in the case where it is determined by the determination unit that coding is performed using the second coding unit, to switch between the first coding unit and the second coding unit in units of blocks and to code information indicating that switching is performed in units of blocks as block-by-block mode-switching information.

13. An apparatus for decoding an image bit stream to reproduce an image, the apparatus comprising:
a first decoding unit configured to decode a block coded in a first coding mode in which inverse quantization is performed;
a second decoding unit configured to decode a block coded in a second coding mode in which inverse quantization is not performed;
a separating and decoding unit configured to decode a bit stream to decode information indicating that switching between first coding and second coding is performed in units of blocks as block-by-block mode-switching information; and
a determination unit configured to switch between the first decoding unit and the second decoding unit in units of blocks.

14. A computer-readable program that causes a computer to function as the image coding apparatus according to claim 12.

15. A computer-readable program that causes a computer to function as the image decoding apparatus according to claim 13.
